(19) United States
(12) Patent Application Publication
(10) Pub. No.: US 2013/0053029 A1
(43) Pub. Date: Feb. 28, 2013

(54) SUPPORTING SERVICES TO A ROAMING USER EQUIPMENT WITHIN A LOCAL NETWORK OF A WIRELESS COMMUNICATIONS SYSTEM

(71) Applicant: Kirankumar Anchan, San Diego, CA (US)

(72) Inventor: Kirankumar Anchan, San Diego, CA (US)

(21) Appl. No.: 13/216,090

(22) Filed: Aug. 23, 2011

(51) Int. Cl. H04W 8/18

(52) U.S. Cl. 455/432.3

(57) ABSTRACT

In an embodiment, an SGSN determines whether a local network is configured to support a given service locally. The SGSN receives an Activate PDP Context Request message associated with the given service from a roaming UE and selectively terminates a PDP for the given service within the local network based at least in part upon the determination. In another embodiment, an MME determines whether the local network is configured to support the given service locally. The MME receives a PDN Connectivity Request message associated with the given service from the roaming UE, and selectively terminates an EPS Bearer for the given service within the local network based at least in part upon the determination. In the respective embodiments, the SGSN and/or the MME are configured to ignore HLR settings for PDP termination and/or EPS Bearer termination, respectively, of the UE.

### BACKGROUND OF THE INVENTION

1. Field of the Invention

Embodiments of the invention relate to supporting services to a roaming user equipment (UE) within a local network of a wireless communications system.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data, Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (W-CDMA), CDMA2000 (such as CDMA2000 1xEV-DO standards, for example) or TD-SCDMA.

In W-CDMA wireless communication systems, user equipments (UEs) receive signals from fixed position Node Bs (also referred to as cell sites or cells) that support communication links or service within particular geographic regions adjacent to or surrounding the base stations. Node Bs provide entry points to an access network (AN) or radio access network (RAN), which is generally a packet data network using standard Internet Engineering Task Force (IETF) based protocols that support methods for differentiating traffic based on Quality of Service (QoS) requirements. Therefore, the Node Bs generally interact with UEs through an over the air interface and with the RAN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as W-CDMA, CDMA, FDMA, TDMA, GSM, etc. In a dispatch model, communication between endpoints (e.g., UEs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

### SUMMARY

In an embodiment, an SGSN determines whether a local network is configured to support a given service locally. The SGSN receives an Activate PDP Context Request message associated with the given service from a roaming UE and selectively terminates a PDP for the given service within the local network based at least in part upon the determination. In another embodiment, an MME determines whether the local network is configured to support the given service locally. The MME receives a PDN Connectivity Request message associated with the given service from the roaming UE, and selectively terminates an EPS Bearer for the given service within the local network based at least in part upon the determination. In the respective embodiments, the SGSN and/or the MME are configured to ignore HLR settings for PDP termination and/or EPS Bearer termination, respectively, of the UE.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2A illustrates the core network of FIG. 1 according to an embodiment of the present invention.

FIG. 2C illustrates an example of the wireless communications system of FIG. 1 in more detail.

FIG. 3 is an illustration of a user equipment (UE) in accordance with at least one embodiment of the invention.

FIG. 4A illustrates a broad characterization of networks within a conventional wireless communication system with respect to a particular multimedia application.

FIG. 4B illustrates a process of exchanging data between a UE in a roaming network or visited public land mobile network (PLMN) and an application server that is positioned at a home network or home PLMN.

FIG. 4C illustrates a process of exchanging data between a UE in a visited network or visited PLMN and the application server that is positioned at the visited network or visited PLMN.

FIG. 4D illustrates a broad characterization of networks within a wireless communication system with respect to a particular multimedia application in accordance with an embodiment of the invention.

FIG. 5A illustrates an example of setting up a packet data protocol (PDP) context for a given multimedia service at a given UE within the home network and registering with the application server that is configured to support the given multimedia service locally within the home network.

FIG. 5B illustrates an example of setting up a PDP context for the given multimedia service at a given UE within a visited network and registering with the application server that is configured to support the given multimedia service to a visiting UE from the home network.

FIG. 5C illustrates an example of setting up a PDP context for the given multimedia service at a given UE within a visited network and registering with the application server that is configured to support the given multimedia service to a visiting UE from the visited network.

FIG. 6A illustrates a process of setting up a PDP context in accordance with an embodiment of the present invention.

FIG. 6B illustrates a more detailed implementation of the process of FIG. 6A in accordance with another embodiment of the invention.

FIG. 7 illustrates an example of logic that can be included in a network end-point in accordance with an embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as user equipment (UE), may be mobile or stationary, and may communicate with one or more access points (APs), which may be referred to as Node Bs. A UE transmits and receives data packets through one or more of the Node Bs to a Radio Network Controller (RNC). The Node Bs and RNC are parts of a network called a radio access network (RAN). A radio access network can transport voice and data packets between multiple access terminals.

The radio access network may be further connected to additional networks outside the radio access network, such core network including specific carrier related servers and devices and connectivity to other networks such as a corporate intranet, the Internet, public switched telephone network (PSTN), a Serving General Packet Radio Services (GPRS) Support Node (SGSN), a Gateway GPRS Support Node (GGSN), and may transport voice and data packets between each UE and such networks. A UE that has established an active traffic channel connection with one or more Node Bs may be referred to as an active UE, and can be referred to as being in a traffic state. A UE that is in the process of establishing an active traffic channel (TCH) connection with one or more Node Bs can be referred to as being in a connection setup state. A UE may be any data device that communicates through a wireless channel or through a wired channel. A UE may further be any of a number of types of devices including but not limited to PC card, compact flash device, external or internal modem, or wireless or wireline phone. The communication link through which the UE sends signals to the Node B(s) is called an uplink channel (e.g., a reverse traffic channel, a control channel, an access channel, etc.). The communication link through which Node B(s) send signals to a UE is called a downlink channel (e.g., a paging channel, a control channel, a broadcast channel, a forward traffic channel, etc.). As used herein the term traffic channel (TCH) can refer to either an uplink/reverse or downlink/forward traffic channel.

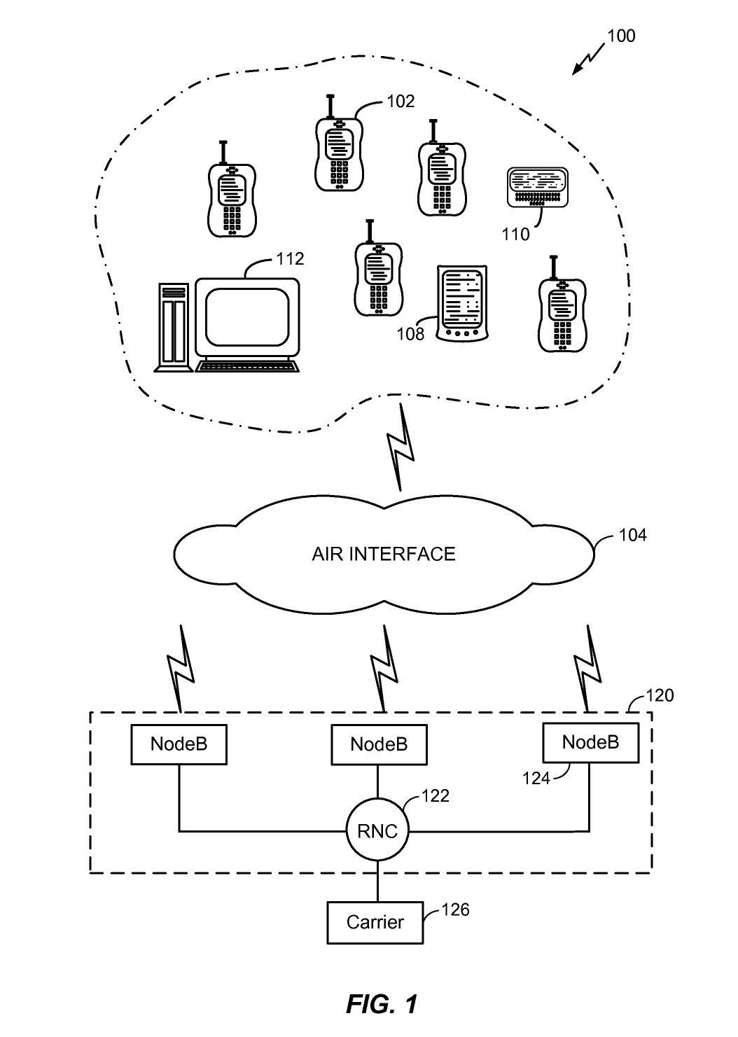

FIG. 1 illustrates a block diagram of one exemplary embodiment of a wireless communications system 100 in accordance with at least one embodiment of the invention. System 100 can contain UEs, such as cellular telephone 102, in communication across an air interface 104 with an access network or radio access network (RAN) 120 that can connect the UE 102 to network equipment providing data connectivity between a packet switched data network (e.g., an intranet, the Internet, and/or core network 126) and the UEs 102, 108, 110, 112. As shown here, the UE can be a cellular telephone 102, a personal digital assistant 108, a pager 110, which is shown here as a two-way text pager, or even a separate computer platform 112 that has a wireless communication portal. Embodiments of the invention can thus be realized on any form of UE including a wireless communication portal or having wireless communication capabilities, including without limitation, wireless modems, PCMCIA cards, personal computers, telephones, or any combination or sub-combination thereof. Further, as used herein, the term “UE” in other communication protocols (i.e., other than W-CDMA) may be referred to interchangeably as an “access terminal”, “AT”, “wireless device”, “client device”, “mobile terminal”, “mobile station” and variations thereof.

Referring back to FIG. 1, the components of the wireless communications system 100 and interrelation of the elements of the exemplary embodiments of the invention are not limited to the configuration illustrated. System 100 is merely exemplary and can include any system that allows remote UEs, such as wireless client computing devices 102, 108, 110, 112 to communicate over-the-air between and among each other and/or between and among components connected via the air interface 104 and RAN 120, including, without limitation, core network 126, the Internet, PSTN, SGSN, GGSN and/or other remote servers.

The RAN 120 controls messages (typically sent as data packets) sent to an RNC 122. The RNC 122 is responsible for signaling, establishing, and tearing down bearer channels (i.e., data channels) between a Serving General Packet Radio Services (GPRS) Support Node (SGSN) and the UEs 102/108/110/112. If link layer encryption is enabled, the RNC 122 also encrypts the content before forwarding it over the air interface 104. The function of the RNC 122 is well-known in the art and will not be discussed further for the sake of brevity. The core network 126 may communicate with the RNC 122 by a network, the Internet and/or a public switched telephone network (PSTN). Alternatively, the RNC 122 may connect directly to the Internet or external network. Typically, the network or Internet connection between the core network 126 and the RNC 122 transfers data, and the PSTN transfers voice information. The RNC 122 can be connected to multiple Node Bs 124. In a similar manner to the core network 126, the RNC 122 is typically connected to the Node Bs 124 by a network, the Internet and/or PSTN for data transfer and/or voice information. The Node Bs 124 can broadcast data messages wirelessly to the UEs, such as cellular telephone 102. The Node Bs 124, RNC 122 and other components may form the RAN 120, as is known in the art. However, alternate configurations may also be used and the invention is not limited to the configuration illustrated. For example, in another embodiment the functionality of the RNC 122 and one or more of the Node Bs 124 may be collapsed into a single “hybrid” module having the functionality of both the RNC 122 and the Node B(s) 124.

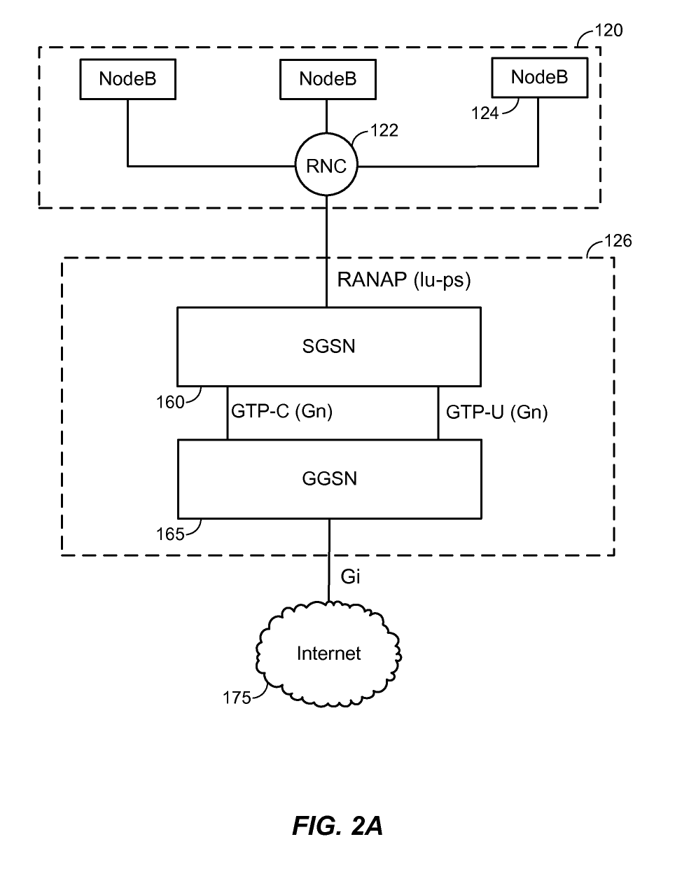

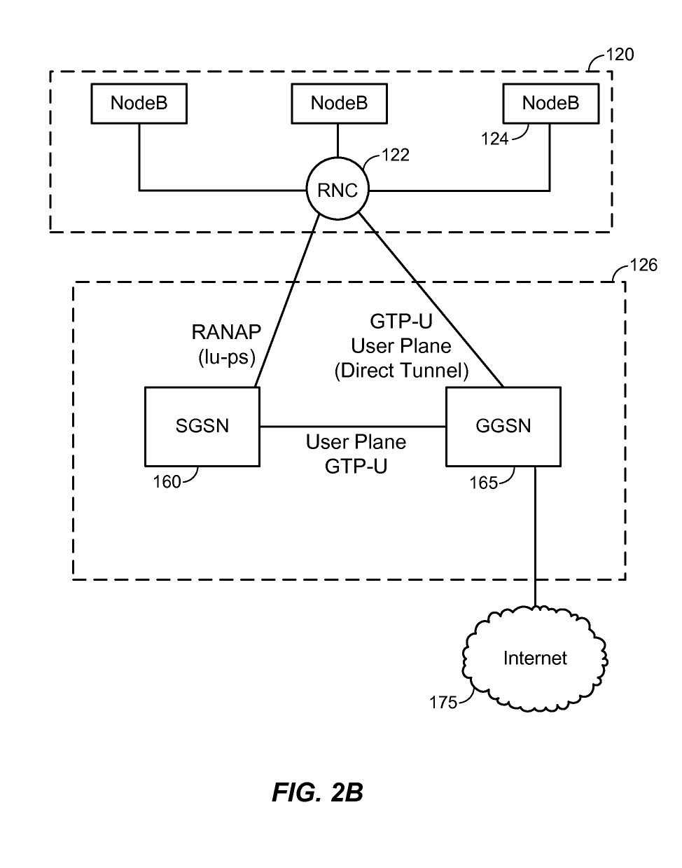

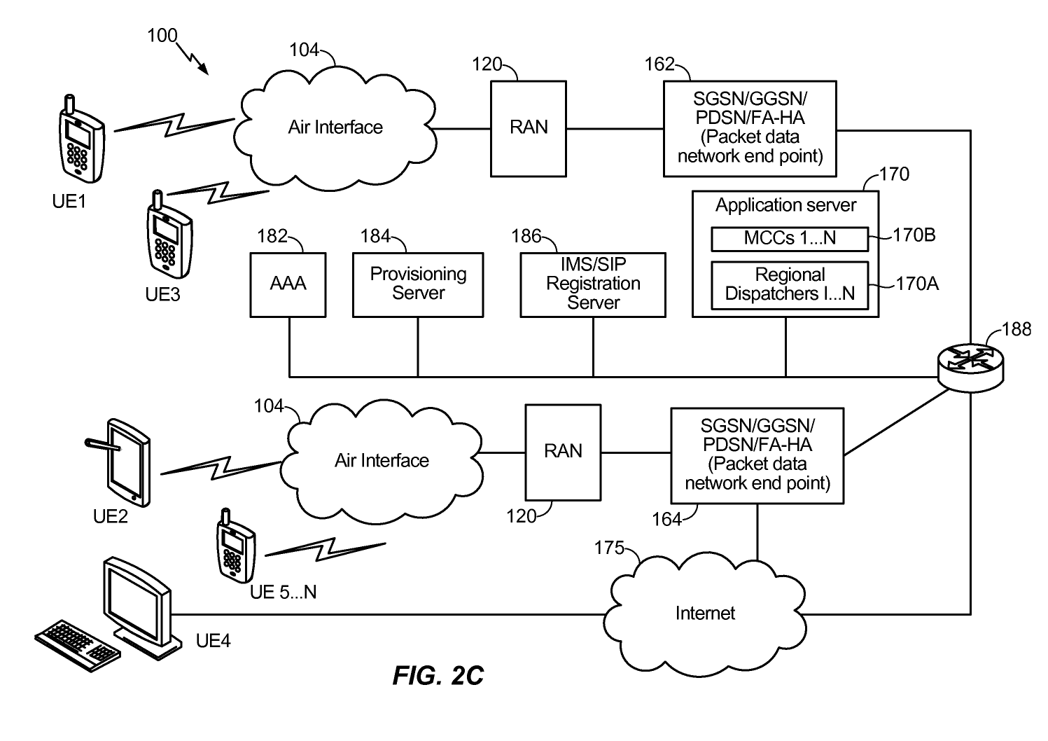

FIG. 2A illustrates the core network 126 according to an embodiment of the present invention. In particular, FIG. 2A illustrates components of a General Packet Radio Services (GPRS) core network implemented within a W-CDMA system. In the embodiment of FIG. 2A, the core network 126 includes a Serving GPRS Support Node (SGSN) 160, a Gateway GPRS Support Node (GGSN) 165 and an Internet 175. However, it is appreciated that portions of the Internet 175 and/or other components may be located outside the core network in alternative embodiments.

Generally, GPRS is a protocol used by Global System for Mobile communications (GSM) phones for transmitting Internet Protocol (IP) packets. The GPRS Core Network (e.g., the GGSN 165 and one or more SGSNs 160) is the centralized part of the GPRS system and also provides support for W-CDMA based 3G networks. The GPRS core network is an integrated part of the GSM core network, provides mobility management, session management and transport for IP packet services in GSM and W-CDMA networks.

The GPRS Tunneling Protocol (GTP) is the defining IP protocol of the GPRS core network. The GTP is the protocol which allows end users (e.g., UEs) of a GSM or W-CDMA network to move from place to place while continuing to connect to the internet as if from one location at the GGSN 165. This is achieved transferring the subscriber's data from the subscriber's current SGSN 160 to the GGSN 165, which is handling the subscriber's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2A, the GGSN 165 acts as an interface between the GPRS backbone network (not shown) and the Internet (i.e., an external packet data network) 175. The GGSN 165 extracts the packet data with associated packet data protocol (PDP) format (e.g., IP or PPP) from the GPRS packets coming from the SGSN 160, and sends the packets out on a corresponding packet data network. In the other direction, the incoming data packets are directed by the GGSN 165 to the SGSN 160 which manages and controls the Radio Access Bearer (RAB) of the destination UE served by the RAN 120. Thereby, the GGSN 165 stores the current SGSN address of the target UE and his/her profile in its location register (e.g., within a PDP context). The GGSN is responsible for IP address assignment and is the default router for the connected UE. The GGSN also performs authentication and charging functions.

The SGSN 160 is representative of one of many SGSNs within the core network 126, in an example. Each SGSN is responsible for the delivery of data packets from and to the UEs within an associated geographical service area. The tasks of the SGSN 160 includes packet routing and transfer, mobility management (e.g., attach/detach and location management), logical link management, and authentication and charging functions. The location register of the SGSN stores location information (e.g., current cell, current VLR) and user profiles (e.g., IMSI, PDP address(es) used in the packet data network) of all GPRS users registered with the SGSN 160, for example, within one or more PDP contexts for each user or UE. Thus, SGSNs are responsible for (i) de-tunneling downlink GTP packets from the GGSN 165, (ii) uplink tunnel IP packets toward the GGSN 165, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in Universal Mobile Telecommunications System (UMTS) system architecture) communicates with the SGSN 160 via a Radio Access Network Application Part (RANAP) protocol. RANAP operates over a Iu interface (Iu-ps), with a transmission protocol such as Frame Relay or IP. The SGSN 160 communicates with the GGSN 165 via a Gn interface, which is an IP-based interface between SGSN 160 and other SGSNs (not shown) and internal GGSNs, and uses the GTP protocol defined above (e.g., GTP-U, GTP-C, GTP′, etc.). In the embodiment of FIG. 2A, the Gn between the SGSN 160 and the GGSN 165 carries both the GTP-C and the GTP-U. While not shown in FIG. 2A, the Gn interface is also used by the Domain Name System (DNS). The GGSN 165 is connected to a Public Data Network (PDN) (not shown), and in turn to the Internet 175, via a Gi interface with IP protocols either directly or through a Wireless Application Protocol (WAP) gateway.

FIG. 2B illustrates the core network 126 according to another embodiment of the present invention. FIG. 2B is similar to FIG. 2A except that FIG. 2B illustrates an implementation of direct tunnel functionality.

Direct Tunnel is an optional function in Iu mode that allows the SGSN 160 to establish a direct user plane tunnel, GTP-U, between RAN and GGSN within the Packet Switched (PS) domain. A direct tunnel capable SGSN, such as SGSN 160 in FIG. 2B, can be configured on a per GGSN and per RNC basis whether or not the SGSN can use a direct user plane connection. The SGSN 160 in FIG. 2B handles the control plane signaling and makes the decision of when to establish Direct Tunnel. When the Radio Bearer (RAB) assigned for a PDP context is released (i.e. the PDP context is preserved) the GTP-U tunnel is established between the GGSN 165 and SGSN 160 in order to be able to handle the downlink packets.

The optional Direct Tunnel between the SGSN 160 and GGSN 165 is not typically allowed (i) in the roaming case (e.g., because the SGSN needs to know whether the GGSN is in the same or different PLMN), (ii) where the SGSN has received Customized Applications for Mobile Enhanced Logic (CAMEL) Subscription Information in the subscriber profile from a Home Location Register (HLR) and/or (iii) where the GGSN 165 does not support GTP protocol version 1. With respect to the CAMEL restriction, if Direct Tunnel is established then volume reporting from SGSN 160 is not possible as the SGSN 160 no longer has visibility of the User Plane. Thus, since a CAMEL server can invoke volume reporting at anytime during the life time of a PDP Context, the use of Direct Tunnel is prohibited for a subscriber whose profile contains CAMEL Subscription Information.

The SGSN 160 can be operating in a Packet Mobility Management (PMM)-detached state, a PMM-idle state or a PMM-connected state. In an example, the GTP-connections shown in FIG. 2B for Direct Tunnel function can be established whereby the SGSN 160 is in the PMM-connected state and receives an Iu connection establishment request from the UE. The SGSN 160 ensures that the new Iu connection and the existing Iu connection are for the same UE, and if so, the SGSN 160 processes the new request and releases the existing Iu connection and all RABs associated with it. To ensure that the new Iu connection and the existing one are for the same UE, the SGSN 160 may perform security functions. If Direct Tunnel was established for the UE, the SGSN 160 sends an Update PDP Context Request(s) to the associated GGSN(s) 165 to establish the GTP tunnels between the SGSN 160 and GGSN(s) 165 in case the Iu connection establishment request is for signaling only. The SGSN 160 may immediately establish a new direct tunnel and send Update PDP Context Request(s) to the associated GGSN(s) 165 and include the RNC's Address for User Plane, a downlink Tunnel Endpoint Identifier (TEID) for data in case the Iu connection establishment request is for data transfer.

The UE also performs a Routing Area Update (RAU) procedure immediately upon entering PMM-IDLE state when the UE has received an RRC Connection Release message with cause “Directed Signaling connection re-establishment” even if the Routing Area has not changed since the last update. In an example, the RNC will send the RRC Connection Release message with cause “Directed Signaling Connection re-establishment” when the RNC is unable to contact the Serving RNC to validate the UE due to lack of Iur connection (e.g., see TS 25.331[52]). The UE performs a subsequent service request procedure after successful completion of the RAU procedure to re-establish the radio access bearer when the UE has pending user data to send.

The PDP context is a data structure present on both the SGSN 160 and the GGSN 165 which contains a particular UE's communication session information when the UE has an active GPRS session. When a UE wishes to initiate a GPRS communication session, the UE must first attach to the SGSN 160 and then activate a PDP context with the GGSN 165. This allocates a PDP context data structure in the SGSN 160 that the subscriber is currently visiting and the GGSN 165 serving the UE's access point.

FIG. 2C illustrates an example of the wireless communications system 100 of FIG. 1 in more detail. In particular, referring to FIG. 2C, UEs 1 . . . N are shown as connecting to the RAN 120 at locations serviced by different packet data network end-points. The illustration of FIG. 2C is specific to W-CDMA systems and terminology, although it will be appreciated how FIG. 2C could be modified to conform with a 1×EV-DO system. Accordingly, UEs 1 and 3 connect to the RAN 120 at a portion served by a first packet data network end-point 162 (e.g., which may correspond to SGSN, GGSN, PDSN, a home agent (HA), a foreign agent (FA), etc.). The first packet data network end-point 162 in turn connects, via the routing unit 188, to the Internet 175 and/or to one or more of an authentication, authorization and accounting (AAA) server 182, a provisioning server 184, an Internet Protocol (IP) Multimedia Subsystem (IMS)/Session Initiation Protocol (SIP) Registration Server 186 and/or the application server 170. UEs 2 and 5 . . . N connect to the RAN 120 at a portion served by a second packet data network end-point 164 (e.g., which may correspond to SGSN, GGSN, PDSN, FA, HA, etc.). Similar to the first packet data network end-point 162, the second packet data network end-point 164 in turn connects, via the routing unit 188, to the Internet 175 and/or to one or more of the AAA server 182, a provisioning server 184, an IMS/SIP Registration Server 186 and/or the application server 170. UE 4 connects directly to the Internet 175, and through the Internet 175 can then connect to any of the system components described above.

Referring to FIG. 2C, UEs 1, 3 and 5 . . . N are illustrated as wireless cell-phones, UE 2 is illustrated as a wireless tablet-PC and UE 4 is illustrated as a wired desktop station. However, in other embodiments, it will be appreciated that the wireless communication system 100 can connect to any type of UE, and the examples illustrated in FIG. 2C are not intended to limit the types of UEs that may be implemented within the system. Also, while the AAA 182, the provisioning server 184, the IMS/SIP registration server 186 and the application server 170 are each illustrated as structurally separate servers, one or more of these servers may be consolidated in at least one embodiment of the invention.

Further, referring to FIG. 2C, the application server 170 is illustrated as including a plurality of media control complexes (MCCs) 1 . . . N 170B, and a plurality of regional dispatchers 1 . . . N 170A. Collectively, the regional dispatchers 170A and MCCs 170B are included within the application server 170, which in at least one embodiment can correspond to a distributed network of servers that collectively functions to arbitrate communication sessions (e.g., half-duplex group communication sessions via IP unicasting and/or IP multicasting protocols) within the wireless communication system 100. For example, because the communication sessions arbitrated by the application server 170 can theoretically take place between UEs located anywhere within the system 100, multiple regional dispatchers 170A and MCCs are distributed to reduce latency for the arbitrated communication sessions (e.g., so that an MCC in North America is not relaying media back-and-forth between session participants located in China). Thus, when reference is made to the application server 170, it will be appreciated that the associated functionality can be enforced by one or more of the regional dispatchers 170A and/or one or more of the MCCs 170B. The regional dispatchers 170A are generally responsible for any functionality related to establishing a communication session (e.g., handling signaling messages between the UEs, scheduling and/or sending announce messages, etc.), whereas the MCCs 170B are responsible for hosting the communication session for the duration of the call instance, including conducting an in-call signaling and an actual exchange of media during an arbitrated communication session.

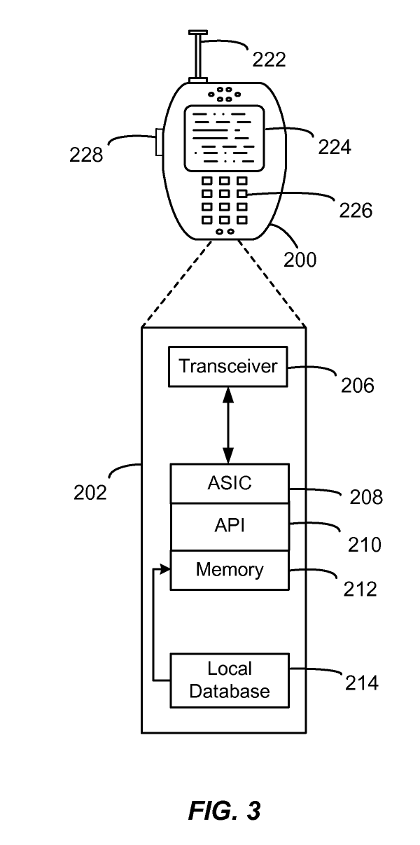

Referring to FIG. 3, a UE 200, (here a wireless device), such as a cellular telephone, has a platform 202 that can receive and execute software applications, data and/or commands transmitted from the RAN 120 that may ultimately come from the core network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include a UE including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UE 200 in FIG. 3 are to be considered merely illustrative and the invention is not limited to the illustrated features or arrangement.

The wireless communication between the UE 102 or 200 and the RAN 120 can be based on different technologies, such as code division multiple access (CDMA), W-CDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. For example, in W-CDMA, the data communication is typically between the client device 102, Node B(s) 124, and the RNC 122. The RNC 122 can be connected to multiple data networks such as the core network 126, PSTN, the Internet, a virtual private network, a SGSN, a GGSN and the like, thus allowing the UE 102 or 200 access to a broader communication network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

Multimedia and real time applications configured to handle server-arbitrated communication sessions (e.g., VoIP sessions, PTT sessions, data sharing sessions, etc.) on cellular networks typically deploy an ‘always-on’ packet data service or data session and use multiple links (for e.g., multiple PDP contexts in case of a UMTS system or multiple PPP sessions in case of CDMA systems) to enable mobile terminated (MT) signaling while the mobile is inactive and to improve performance. To achieve the always-on data service on cellular networks, multimedia applications employ keep alive mechanisms and/or other network-based mechanism (e.g., long dormancy timers, etc.) in order to provide reliable service and a good user experience. The network may further assist delay sensitive application with preferential Quality of Service (QoS) treatment.

These types of optimized or enhanced services on networks are typically available in the home network of the cellular application provider that provides such specialized services like PTT over packet switched network and VoIP like applications. The services are also typically available on affiliate networks, which are not true home networks but are configured to allocate resources to the UEs in a similar manner as in the home network. When the UEs roam to a roaming network (i.e., a non-home and non-affiliate network) and packet data roaming is allowed in the roaming network, the enhanced services (e.g., always-on data session, multiple PDPs, preferential QoS, etc.) may not be available to the roaming UEs.

Under such circumstances the network assumptions considered for supporting the multimedia application in the home network are no longer valid. For example, the multimedia application may be configured to function with the assumption that the always-on data session is available. Thus, if the always-on data session is not supported in the roaming network, the multimedia application may not receive any mobile terminated data when the mobile is idle and the multimedia application may not function properly. In another example, the multimedia application may be configured to function with the assumption that its packet transfer will be supported with expedited data forwarding treatment (e.g., reduced latency, etc.). Thus, if the multimedia application is not allocated the expedited data forwarding treatment in the roaming network, the performance of the multimedia application may diverge from expectations.

As will be appreciated, the network conditions in the roaming network are difficult for the UEs to predict (e.g., some roaming networks may provide full support for the multimedia application while others may not) and can potentially be disruptive to the multimedia application's operation. Also, the battery performance of the UE can degrade in roaming networks if the UE performs operations that are designed for the home and/or affiliate networks which are wasted in the roaming networks. Accordingly, in the roaming networks, the multimedia application will typically either fail to work or will work with compromised quality that can impact the user experience and/or battery life of the UE.

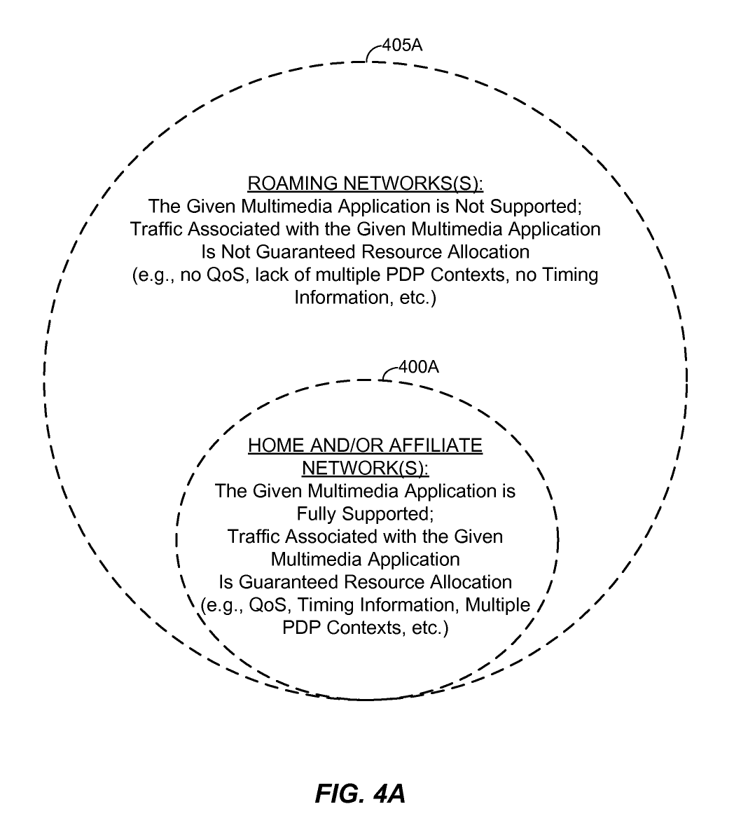

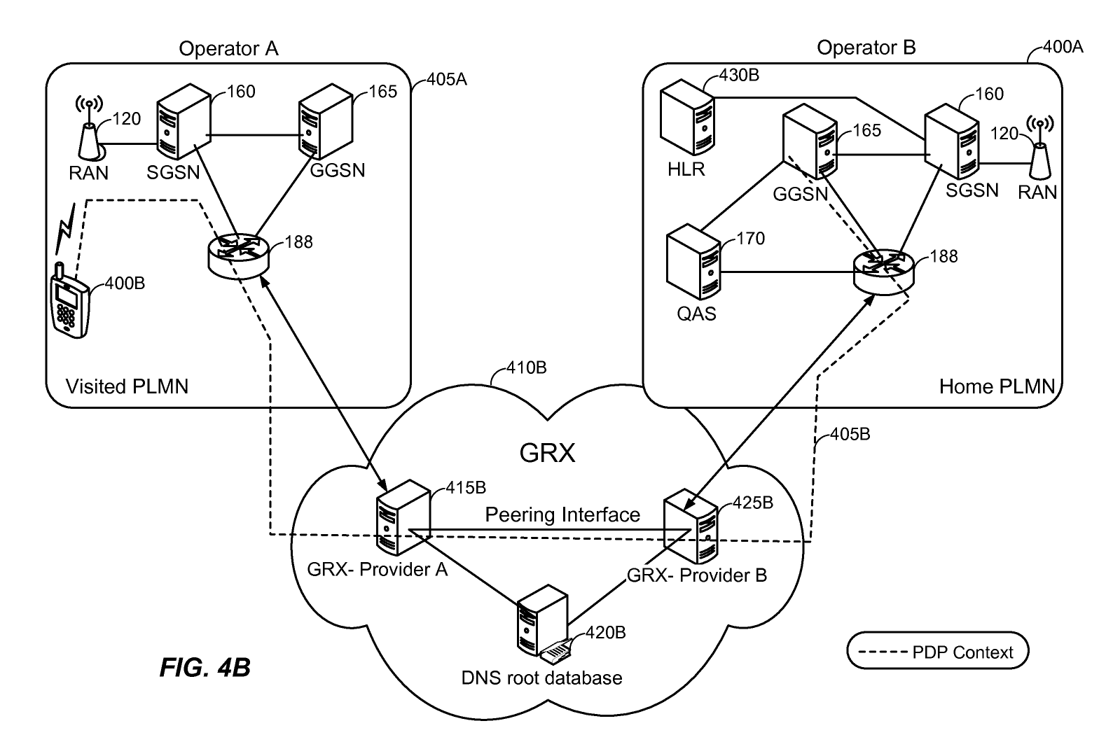

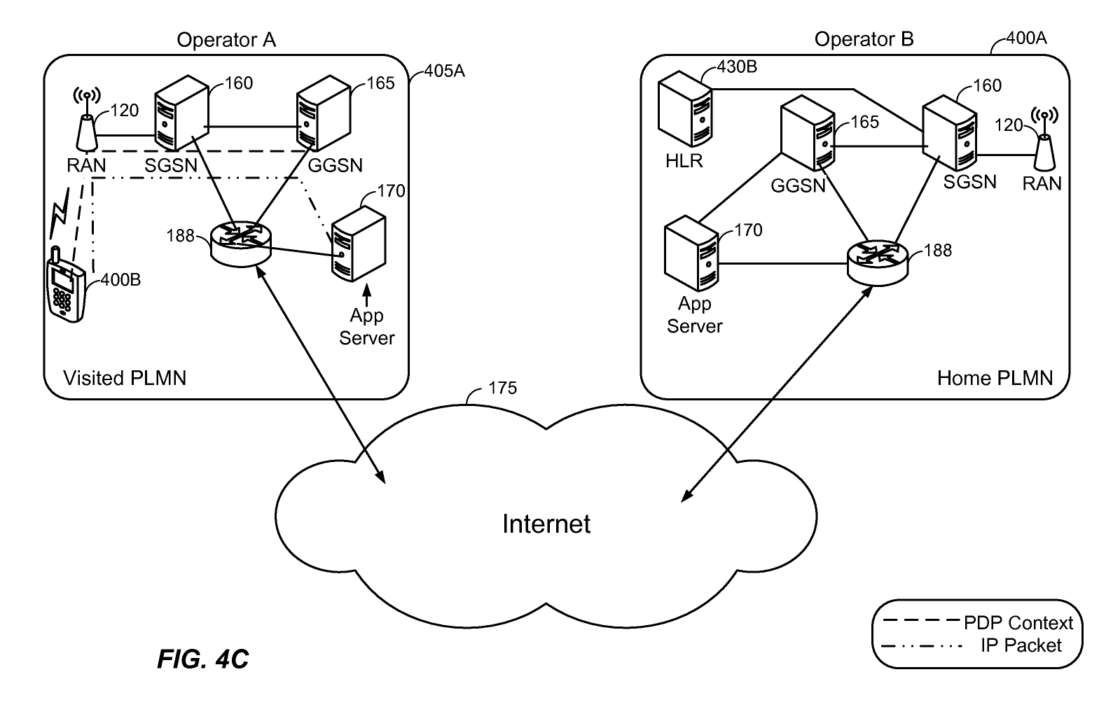

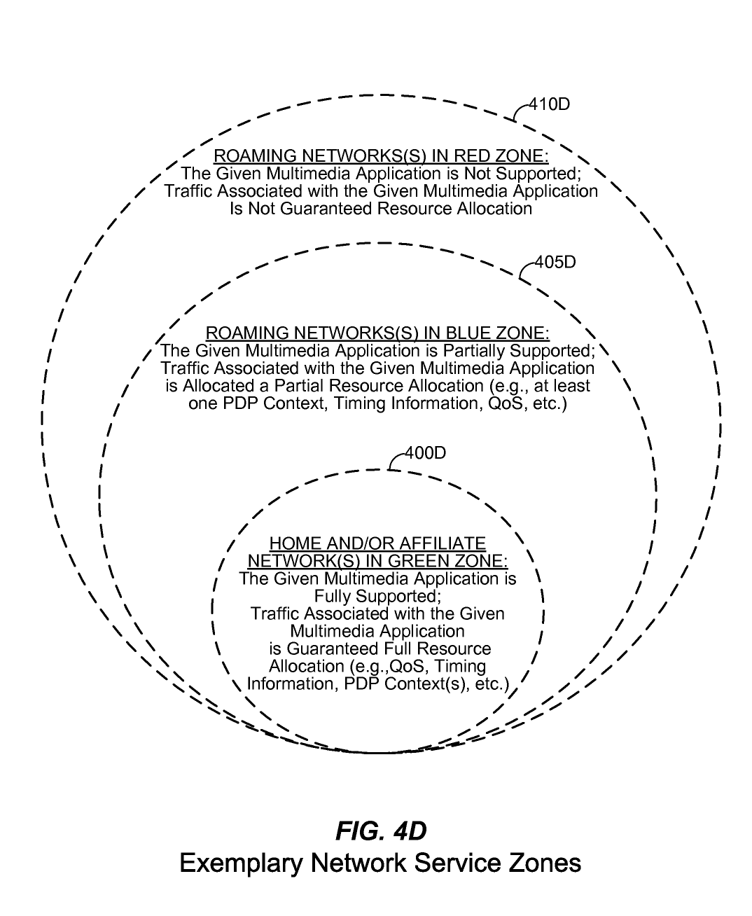

FIG. 4A illustrates a broad characterization of networks within a conventional wireless communication system with respect to a particular multimedia application. Referring to FIG. 4A, a plurality of home and/or affiliate networks 400A are shown in relation to a plurality of roaming networks 405A. The home and/or affiliate networks 400A correspond to networks where the multimedia application is fully supported. For example, in the home and/or affiliate networks, the multimedia application may be allocated an always-on data session (e.g., with two always-on PDP contexts), the multimedia application is informed of the relevant timing information used by the multimedia application for timestamp-based authentication credential generation in a client-server model, the multimedia application is allocated a given amount of QoS resources, etc. On the other hand, the roaming networks 405A are not necessarily configured to fully support the multimedia application. Accordingly, the multimedia application has no guarantees with regard to QoS, multiple PDP contexts, the always-on data session and/or knowledge of the timing information in the roaming networks. Conventionally, despite the support restrictions in the roaming networks 405A, the multimedia application will attempt to execute support processes in the same manner irrespective of whether its UE is currently connected to one of the home and/or affiliate networks 400A or to one of the roaming networks 405A. However, the lack of the timing information will prevent the multimedia application from registering with the application server 170 if the authentication credentials are dependent on time and obtaining service. The multimedia application may also miss some provisioning updates with regards to the multimedia application due to the lack of the timing information.

To ensure that the multimedia application will function correctly in the roaming network, it is conventional for PDP contexts to terminate at the home GGSN (HGGSN) irrespective of where the UE executing the multimedia application is actually located. For example, high-performance PTT or Mobile TV services often require special application servers 170 that are positioned in the operator's home network. Thus, to provide roaming users with seamless experience when the users are on roaming networks (e.g., UTMS networks, etc.), the operators require the PDP to be terminated in the home network. As will be appreciated, this necessitates tunneling of traffic from the HGGSN to the UE's roaming network, which consumes network resources and also adds significant latency.

FIG. 4B illustrates the manner in which a given UE 400B can send data from a roaming network 405A or visited public land mobile network (PLMN) to the application server 170 that is positioned at a home network 400A or home PLMN. As shown in FIG. 4B, the given UE 400B has a PDP context established for routing data between the given UE 400B in the roaming network 405A and the application server 170 that terminates in the home network 400A.

For example, the given UE 400B can send data to the roaming RAN 120 which is forwarded to the roaming SGSN 160, the roaming routing unit 188 and then to a GRPS roaming exchange (GRX) network 410B. The GRX network 410B includes a GRX server 415B for the roaming network 405B (or Provider A), a Domain Name System (DNS) roots database 420B and a GRX server 425B for the home network 400A (or Provider B). In the GRX network 410B, data from the given UE 400B arrives at GRX server 415B and is forwarded over a peering interface to the GRX server 425B. The data is then forwarded from the GRX server 425B to the home routing unit 188, the home GGSN 165 and the application server 170 (or QAS). Also shown in the home network 400A is a home location register (HLR) 430B. As will be appreciated, a similar routing path can be implemented for data sent back to the given UE 400B from the application server 170.

While automatically terminating the PDP context in the home network helps to ensure that the multimedia application is adequately supported, as noted above, it also introduces latency to traffic that is tunneled from the home network to the roaming network of the UE. The latency problem can be mitigated by permitting PDP contexts to terminate in whichever network the UE is currently camped on (i.e., roaming, home or affiliate), shown below in FIG. 4C. However, it will be appreciated that while this approach can reduce latency, always terminating a PDP context in a current serving network can create other problems if the current serving network does not fully support the multimedia application.

FIG. 4C illustrates another example in which a given UE 400B can send data from a roaming network 405A or visited PLMN to the application server 170 that is positioned at the roaming network 405A or visited PLMN. Conventionally, the UE's network settings (e.g. HLR roaming settings) or the visited networks policy on PDP termination (e.g. always terminate PDP in the local network) determine the PDP termination. It is possible that the only way to get IP connectivity in a roaming scenario is when the packet data session is always terminated in the roaming network 405A. In case of specific multimedia applications like PTT, VoIP, etc., when the application server 170 is also located in the visited or roaming network and can be discovered by the application client on the UE 400B, the multimedia application or service can also be supported in the roaming network 405A.

Without the presence of the application server 170 in the roaming network 405A, the multimedia application or service may not be possible in cases where PDP is terminated in the visited networks. This is because the routing of the original IP packet from the roaming network 405A to the application server 170 in the home network 400A may be blocked as a result of firewall restrictions or private IP addressing for some application server 170 deployments. Intermediate network components may perform some IP header manipulation (e.g. NAT or IP tunneling) to deliver the IP packets to private IP addresses in home network in case a special routing agreement exists between the home and the visited networks. However such IP header manipulations may break any IP header based authentication mechanism in the multimedia application.

As shown in FIG. 4C, the given UE 400B has a PDP context terminated in the roaming network 405A for routing data between the given UE 400B in the roaming network 405A and the application server 170 in the roaming network 405A. For example, the given UE 400B can send data (e.g., an Internet Protocol (IP) packet) to the roaming RAN 120 which is forwarded to the roaming GGSN 165 via the SGSN 160. Since the PDP context is terminated at the roaming GGSN 165, the IP packet is then forwarded by conventional IP routing to the IP application server (or QAS) 170, located in the roaming network 405A. As will be appreciated, a similar routing path can be implemented for data or IP packets sent back to the given UE 400B from the application server 170 in the roaming network 405A.

FIG. 4D illustrates a broad characterization of networks within a wireless communication system with respect to a particular multimedia application in accordance with an embodiment of the invention. Referring to FIG. 4D, the wireless communication system includes a green zone 400D, a blue zone 405D and a red zone 410D. Each of the zones 400D, 405D and 410D include at least one network (e.g., which can be identified via a PLMN ID, for instance) and each of the zones 400D, 405D and 410D is associated with a different expectation of support of the multimedia application.

The green zone 400D includes the home and/or affiliate networks, and green zone networks are configured to provide each of the enhanced operational features expected by the multimedia application, such as an always-on packet data session (e.g., two PDP contexts), a given level of QoS resources, expedited data forwarding, etc. The multimedia application or client that is configured for execution at the given UE is provisioned with green zone specific network procedures that leverage the full-support features expected to be available within the green zone in order to achieve the higher performance and a good user experience. In an example, the given UE can determine whether it is within the green zone 400D based on a mapping of pre-provisioned network IDs to particular zones, or alternatively based on one or more dynamically measured performance parameters. Alternatively the application server 170 can assist the UE in the zone detection

The blue zone 405D includes roaming networks that are expected to provide basic packet data service but are not expected to provide all of the enhanced support features of the green zone 400D. The multimedia application or client that is configured for execution at the given UE is provisioned with blue zone specific network procedures that leverage the partial-support features expected to be available within the blue zone in order to achieve an intermediate performance and an intermediate user experience. In an example, the given UE can determine whether it is within the blue zone 405D based on a mapping of pre-provisioned network IDs to particular zones, or alternatively based on one or more dynamically measured performance parameters and/or assistance from the application server 170.

In an embodiment, networks that belong to the blue zone 405D may have the following requirements for blue zone compliance:
i. Packet data roaming agreement between the roaming network and the home network for QoS or best-effort protocols (e.g., in the absence of QoS);
ii. Multimedia application always finds DNS and application server's IP address (simple Service Discovery);
iii. When always-on PDP is not supported, multimedia application's registration refresh timer can be leveraged to maintain PDP (if relatively long PDP inactivity is applied);
iv. Coordinated Universal Time (UTC) provided by the roaming network (for time based authentication of the multimedia application); and
v. Based on determination by the UE, the multimedia application (or client) on the UE can request the application server 170 (QAS) to assist the UE in setting up dedicated channels.

The red zone 410D includes roaming networks that are expected to provide basic packet data service but are not expected to provide any of the enhanced support features of the green zone 400D or blue zone 405D. For example, red zone networks may not have a roaming agreement with an operator of the home network or the home network operator can deliberately block service to the red zone network. In the red zone, the multimedia application or client refrains from performing any network procedures associated with supporting enhanced support features of the multimedia application, and can also refrain from requesting resources that are expected to be denied by the red zone network. In an example, the given UE can determine whether it is within the red zone 410D based on a mapping of pre-provisioned network IDs to particular zones, or alternatively based on one or more dynamically measured performance parameters and/or based on application server assisted signaling. The reduced operation-level of the multimedia application within the red zone 410D reduces unnecessary messaging and also reduces battery drain of the given UE.

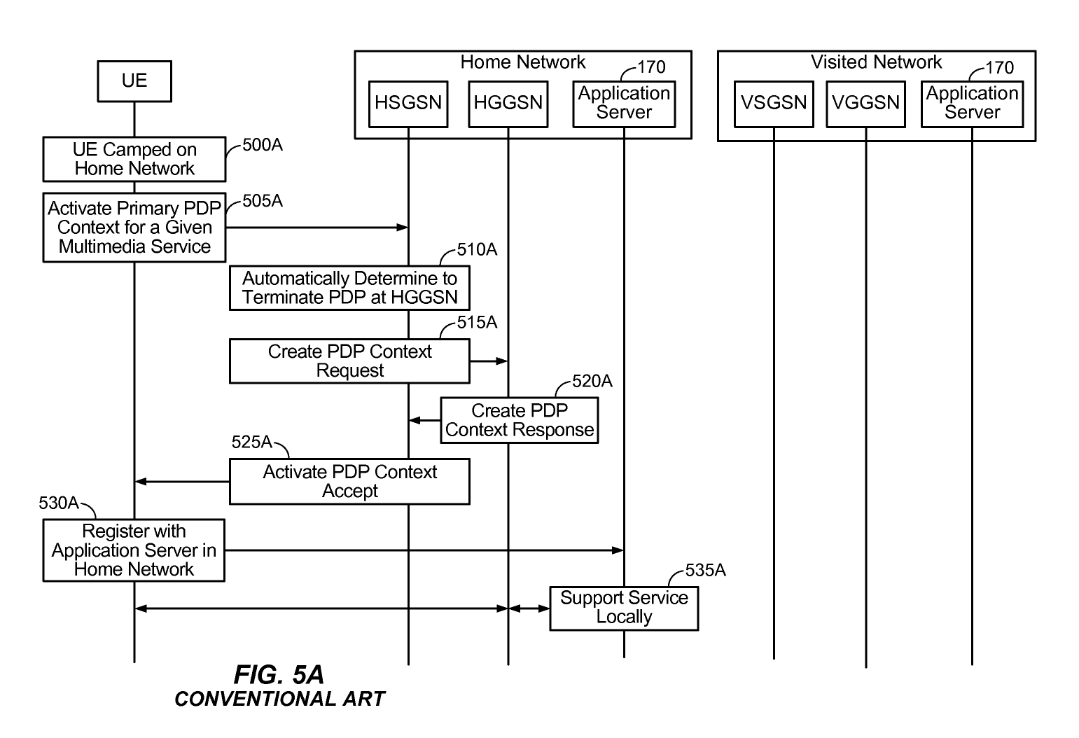

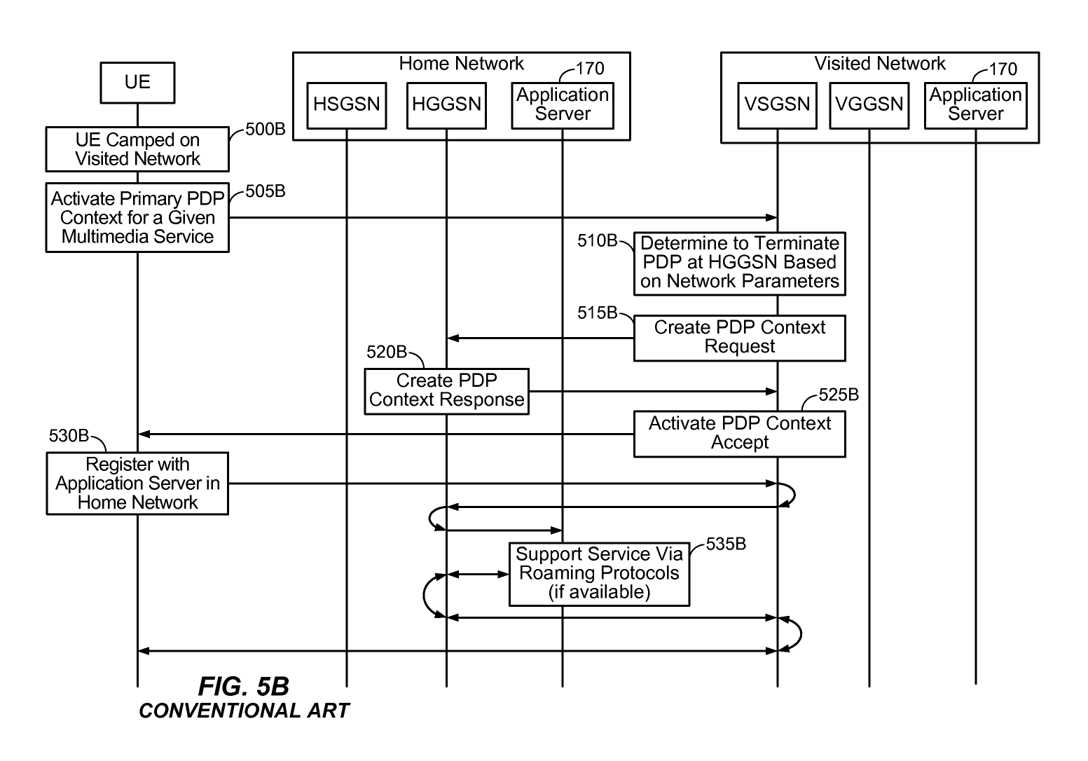

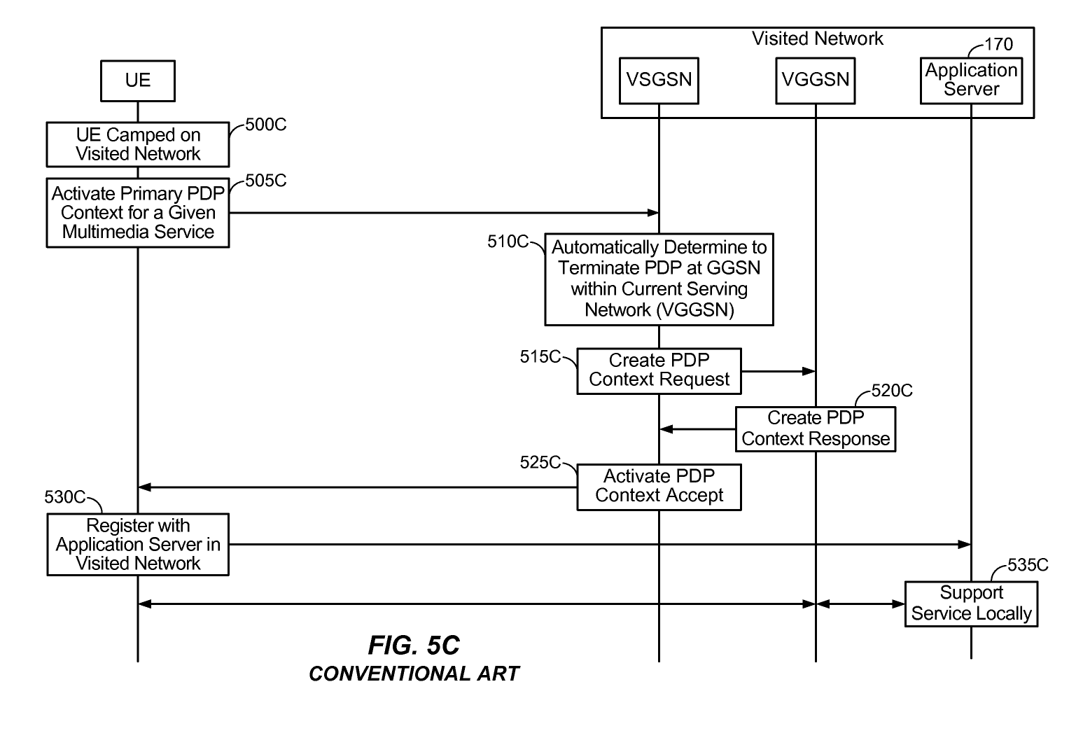

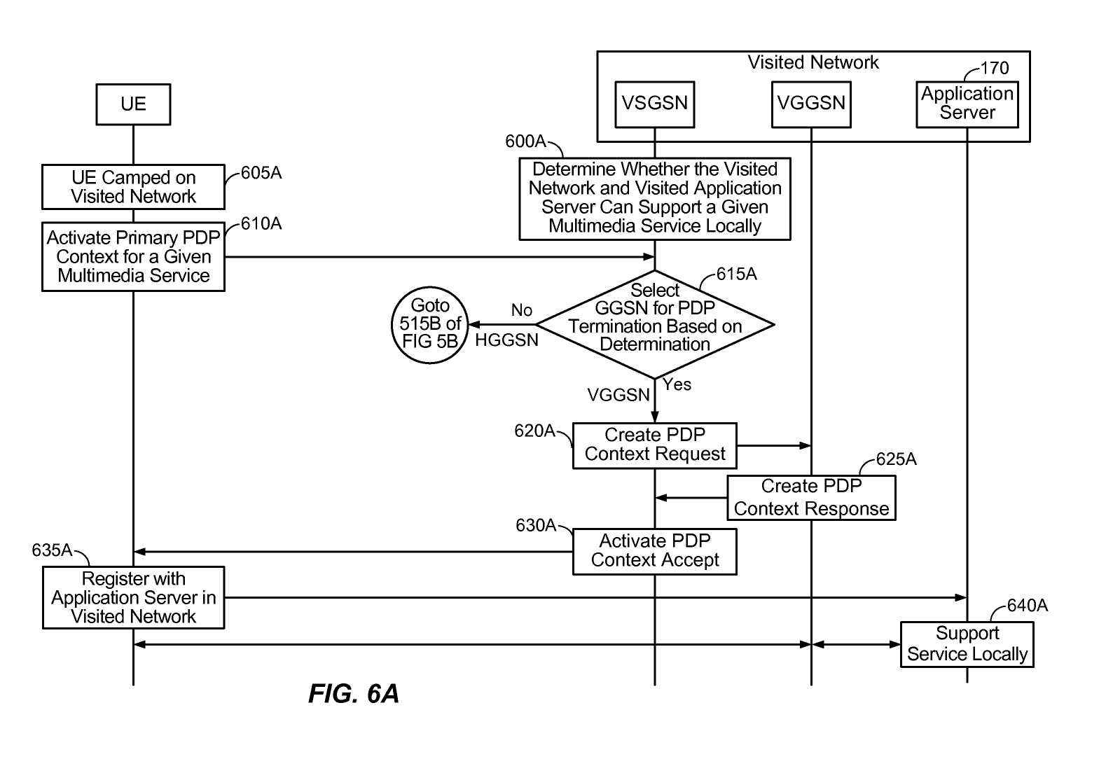

FIG. 5A illustrates an example of setting up a PDP context for a given multimedia service at a given UE within the home network 400A and registering with the application server 170 that is configured to support the given multimedia service locally within the home network 400A. For example, the multimedia service may correspond to any type of service (e.g., PTT, VoIP, mobile TV, an app store, a news service, etc.) that is supported at the given UE via a multimedia application client.

Referring to FIG. 5A, assume that a given UE is camped on the home network 400A (or an affiliate network), 500A. While the given UE remains camped on the home network 400A, the given UE attempts to activate a primary PDP context for the given multimedia service by transmitting an Activate PDP Context Request message to the SGSN 160 within the home network 400A (“HSGSN”), 505A. The HSGSN receives the Activate PDP Context Request message and determines to terminate the PDP for the given UE at the GGSN 165 within the home network 400A (“HGGSN”), 510A. Thus, in 510A, the HSGSN executes a rule, which is specified by the Home Location Register (HLR) settings.

For example, the HLR settings for a given UE provide the UE's IMSI, home PLMN, QoS, and roaming related settings like “VPLMN Address Allowed”. The PDP termination is dependent on the VPLMN Address Allowed setting; when set, this enables the visited SGSN (“VSGSN”) to determine that PDP has to be terminated in the visited or roaming network.

Referring back to 510A, the HSGSN determines, based on the HLR setting, that the PDP for the given UE is to be terminated in the HGGSN. After determining to terminate the PDP for the given UE at the HGGSN, the HSGSN transmits a Create PDP Context Request message to the HGGSN, 515A, and the HGGSN responds with a Create PDP Context Response message, 520A. The HSGSN then notifies the given UE that the PDP context has been established by sending an Activate PDP Context Accept message to the given UE, 525A. After establishing the PDP context, the given UE registers within the application server 170 within the home network 400A, 530A, and the application server 170 can begin to support the given multimedia service locally (i.e., within a current serving network of the given UE, which in this case is the home network 400A) using the PDP context that terminates at the HGGSN, 535A. The primary PDP context that is activated during the process of FIG. 5A may be an “always-on” PDP context in an example, such that the PDP termination point at the HGGSN does not change while the given UE moves throughout the home PLMN wireless communication system and the PDP context need not be re-established.

FIG. 5B illustrates an example of setting up a PDP context for the given multimedia service at a given UE within a visited network and registering with the application server 170 that is configured to support the given multimedia service to a visiting UE from the home network 400A. For example, the multimedia service may correspond to any type of service (e.g., PTT, VoIP, mobile TV, an app store, a news service, etc.) that is supported at the given UE via a multimedia application client.

Referring to FIG. 5B, assume that a given UE is camped on the roaming network 405A, 500B. In an example, the roaming network 405A in FIG. 5B may correspond to a roaming network as described above with respect to FIGS. 4A and/or 4B, and/or a red-zone roaming network 410D or a blue-zone roaming network 405D as shown in FIG. 4D. While the given UE remains camped on the roaming network 405A, the given UE attempts to activate a primary PDP context for the given multimedia service by transmitting an Activate PDP Context Request message to the SGSN 160 within the visited or roaming network (“VSGSN”), 505B. The VSGSN receives the Activate PDP Context Request message and determines to terminate the PDP for the given UE at the GGSN 165 within the home network 400A (“HGGSN”), 510B. Thus, in 510B, the VSGSN executes a rule, which is specified by the Home Location Register (HLR) settings (e.g. VPLMN Not Allowed) for the given UE, whereby the GGSN at which the PDP terminates always corresponds to the HGGSN.

After determining to terminate the PDP for the given UE at the HGGSN, the VSGSN transmits a Create PDP Context Request message to the HGGSN, 515B, and the HGGSN responds with a Create PDP Context Response message, 520B. The VSGSN then notifies the given UE that the PDP context has been established by sending an Activate PDP Context Accept message to the given UE, 525B. Accordingly, after 525B, the PDP context is established as shown in FIG. 4B, such that traffic associated with the PDP context is tunneled between the HGGSN within the home network 400A and the VSGSN within the roaming network 405A.

After establishing the PDP context, the given UE registers within the application server 170 within the home network 400A, 530B, and the application server 170 can begin to support the given multimedia service via roaming protocols using the PDP context that terminates at the HGGSN, 535B. The primary PDP context that is activated during the process of FIG. 5B may be an “always-on” PDP context in an example, such that the PDP termination point at the HGGSN does not change while the given UE moves throughout the visited PLMN wireless communication system and the PDP context need not be re-established.

Referring to FIG. 5C, assume that a given UE is camped on the roaming network 405A, 500C. In an example, the roaming network 405A in FIG. 5C may correspond to a roaming network as described above with respect to FIG. 4C, and/or a red-zone roaming network 410D or a blue-zone roaming network 405D as shown in FIG. 4D. While the given UE remains camped on the roaming network 405A, the given UE attempts to activate a primary PDP context for the given multimedia service by transmitting an Activate PDP Context Request message to the VSGSN, 505C. The VSGSN receives the Activate PDP Context Request message and determines to terminate the PDP for the given UE at the GGSN 165 within the visited or roaming network 405A (“VGGSN”), 510C. More specifically, in 510C, the VSGSN executes a rule, which is specified by the Home Location Register (HLR) settings (e.g. VPLMN Address Allowed) for the given UE, whereby the GGSN at which the PDP terminates always corresponds to a GGSN within a current serving network of the given UE.

After determining to terminate the PDP for the given UE at the VGGSN, the VSGSN transmits a Create PDP Context Request message to the VGGSN, 515C, and the VGGSN responds with a Create PDP Context Response message, 520C. The VSGSN then notifies the given UE that the PDP context has been established by sending an Activate PDP Context Accept message to the given UE, 525C. Accordingly, after 525C, the PDP context is established as shown in FIG. 4C, such that traffic associated with the PDP context is terminated at the VGGSN within the roaming network 405A. After establishing the PDP context, the given UE registers within the application server 170 (if available and discovered by the given UE) within the roaming network 405A, 530C, and the application server 170 within the roaming network 405A attempts to provide local support for the given multimedia service, 535C.

As will be appreciated, the tunneling of data between the home and visited networks, as shown in FIG. 5B, can help to extend support of the given multimedia service to the visited network. However, the tunneling also introduces significant latency to the traffic exchanged between the respective networks, which can degrade performance. One mechanism by which this latency can be reduced is by implementing a rule whereby the PDP context always terminates at a current serving network of the given UE, as shown in FIG. 5C. However, if the visited or roaming network 405A is not actually capable of adequately supporting the given multimedia service (e.g. lack of always-on PDP, lack of application server(s) 170 for supporting the given multimedia service, etc.), the function of the given multimedia service may be degraded by terminating the PDP in the visited or roaming network 405A in FIG. 5C.

Accordingly, embodiments of the invention are directed to determining the GGSN for PDP termination in a more selective manner as compared to always terminating the PDP at the home network (shown in FIGS. 5A and 5B) or always terminating the PDP in a current serving network (shown in FIG. 5C) based on static network settings.

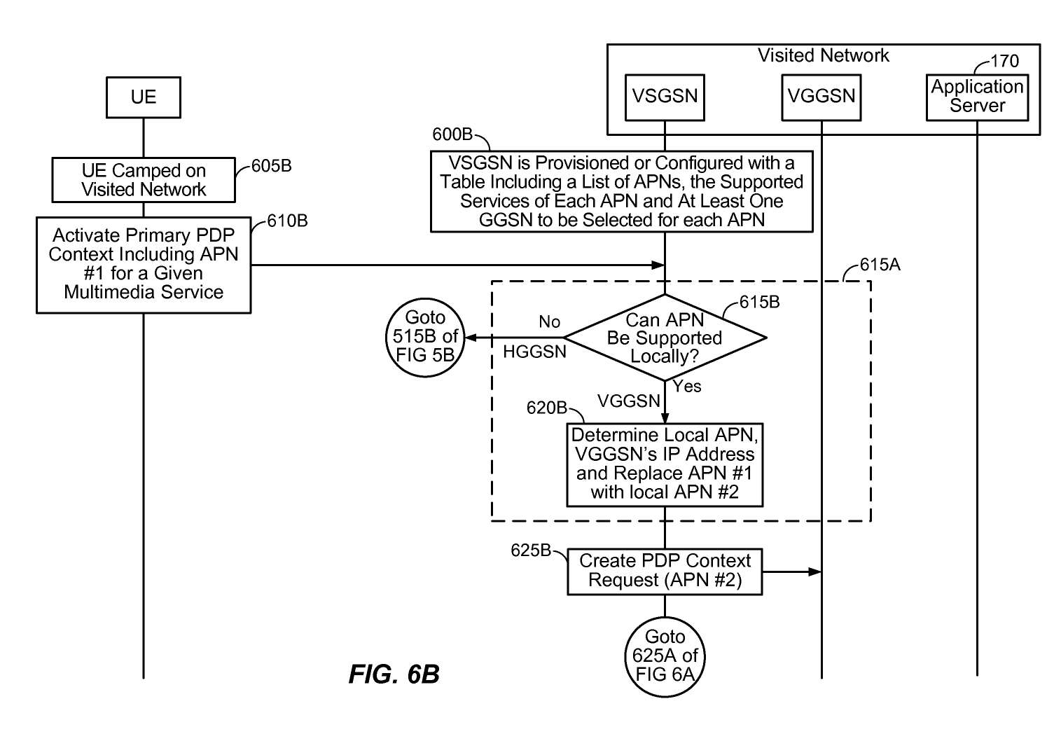

FIG. 6A illustrates a process of setting up a PDP context in accordance with an embodiment of the present invention. In FIG. 6A, a PDP context is established for the given multimedia service by a given UE within the visited or roaming network 405A. Instead of simply selecting the HGGSN for termination of the PDP as in FIGS. 5A and 5B, or alternatively selecting the VGGSN simply because the given UE is currently served by the visiting network, the VSGSN in FIG. 6A is configured to evaluate the service capabilities of the visited network to select the most appropriate network for PDP termination. In other words, the VSGSN is configured to ignore the HLR settings for the given multimedia service that would otherwise dictate where the VSGSN is required to terminate the PDP context. For example, the given multimedia service may correspond to any type of service (e.g., PTT, VoIP, mobile TV, an app store, a news service, etc.) that is supported at the given UE via a multimedia application client.

Referring to FIG. 6A, the VSGSN determines whether the visited or roaming network 405A can support the given multimedia service locally, 600A. For example, the VSGSN can determine that the visited or roaming network 405A can support the given multimedia service locally by comparing a set of performance requirements associated with the given multimedia service with the resources available within the visited or roaming network 405A. In an example, the given multimedia service corresponds to Push-to-Talk (PTT), the set of performance requirements includes air interface requirements (e.g., such as Quality of Service (QoS)) such that the determination of 600A is based on whether the set of performance requirements are satisfied by the resources available within the visited or roaming network 405A. Additional examples of the determination of 600A are described in more detail with respect to FIG. 6B.

Referring to FIG. 6A, assume that the given UE is camped on the visited or roaming network 405A, 605A. In an example, the visited or roaming network 405A in FIG. 6A may correspond to a roaming network as described above with respect to FIG. 4A, 4B or 4C, and/or a red-zone roaming network 410D or a blue-zone roaming network 405D as shown in FIG. 4D. While the given UE remains camped on the visited network, the given UE attempts to activate a primary PDP context for the given multimedia service by transmitting an Activate PDP Context Request message to the SGSN 160 within the visited network (“VSGSN”), 610A. The VSGSN receives the Activate PDP Context Request message, determines that the given UE is roaming in the visited or roaming network 405A, and then selects a target GGSN at which to terminate the PDP context for the given multimedia service based at least in part on the determination from 600A, 615A. As will be appreciated, in 615A, the VSGSN is configured to ignore the HLR settings for the given UE that normally instruct the VSGSN with regard to the manner in which to terminate the PDP context (e.g., always terminate at HGGSN or always terminate at GGSN in current serving network), and instead the VSGSN adopts a more selective approach that is based on the particular capabilities of the visited or roaming network 405A.

Referring to 615A of FIG. 6A, if the VSGSN selects the HGGSN for termination of the PDP context in 615A, the process advances to 515B of FIG. 5B whereby a Create PDP Context Request message is sent by the VSGSN to the HGGSN to facilitate home network termination of the PDP context. Otherwise, if the VSGSN selects the VGGSN for termination of the PDP context, the VSGSN transmits a Create PDP Context Request message to the VGGSN, 620A, and the VGGSN responds with a Create PDP Context Response message, 625A. The VSGSN then notifies the given UE that the PDP context has been established by sending an Activate PDP Context Accept message to the given UE, 630A. Accordingly, after 630A, the PDP context is established as shown in FIG. 4C, such that traffic associated with the PDP context is terminated at the VGGSN within the visited or roaming network 405A. After establishing the PDP context, the given UE registers within the application server 170 within the visited or roaming network 405A, 635A, and the application server 170 within the visited or roaming network 405A attempts to provide local support for the given multimedia service, 640A.

FIG. 6B illustrates a more detailed implementation of the process of FIG. 6A. Referring to FIG. 6B, in 600B, the VSGSN is provisioned (e.g., by the operator in the visited network) with a table that includes (i) a list of Access Point Names (APNs) along with (ii) the supported multimedia services of each listed APN and (iii) an address (e.g., an IP address) of at least one GGSN to be selected in association with each listed APN. In an alternative example, the table can be locally configured at the VSGSN itself.

Referring to FIG. 6B, assume that the given UE is camped on the visited or roaming network 405A, 605B. In an example, the visited or roaming network 405A in FIG. 6B may correspond to a roaming network as described above with respect to FIG. 4A, 4B or 4C, and/or a red-zone roaming network 410D or a blue-zone roaming network 405D as shown in FIG. 4D. While the given UE remains camped on the visited or roaming network 405A, the given UE attempts to activate a primary PDP context for the given multimedia service by transmitting an Activate PDP Context Request message to the VSGSN, 610B. The Activate PDP Context Request message of 610B from the given UE is configured to include an APN that is associated with, or identifies, the given multimedia service.

The VSGSN receives the Activate PDP Context Request message, determines that the given UE is roaming in the visited or roaming network 405A and then evaluates the received APN to determine whether the given multimedia service associated with or identified by the APN can be supported locally, 615B. For example, the VSGSN can compare the received APN with the list of APNs within the table of 600B. From this comparison, the VSGSN can determine either that the visiting network 405A does not support the given multimedia service such that the HGGSN is selected, or that the visiting network 405A supports the given multimedia service such that the VGGSN is selected.

It is also possible that one or more APNs are associated with more than one potential GGSN to select from, in which case secondary criteria can be evaluated to select the GGSN. For example, APNs may not be same across different carriers such as the visited and home networks. Hence, in roaming scenarios, it is possible that an APN for a home carrier of a service (e.g., web browsing, PTT, etc.) is different than an APN for the same service in the visited network. In the visited network, network operations like GGSN selection, billing, etc. are dependent on the APN used by the local operator in the visited network. Thus, if the mapping of the APNs across the carriers for certain services is available and the VSGSN can replace the “home” APN received from the given UE with the local APN (i.e., the visited APN) for the same service, the GGSN selection and other network operation are seamless.

Accordingly, the VSGSN may support APNs for services (e.g., PTT services, etc.) with different APNs as compared to the APN name received in the Activate PDP Context Request message (e.g., because the APN in the Activate PDP Context Request message may correspond to the home network's APN for the service). The VSGSN determines that although the exact APN name is not supported in the visited network, the service is supported by other APNs in the visited network. The VSGSN selects one of the APNs (and hence, a corresponding VGGSN) based on loading of the VGGSN or based on a rule from an established roaming agreement with the home network operator. In 615B of FIG. 6B, if the VSGSN determines to select the HGGSN for termination of the PDP context based on the evaluation of the APN received with the Activate PDP Context Request message, the process advances to 515B of FIG. 5B whereby a Create PDP Context Request message is sent by the VSGSN to the HGGSN to facilitate home network termination of the PDP context.

Otherwise, if the VSGSN determines to select the VGGSN for termination of the PDP context based on the evaluation of the APN received with the Activate PDP Context Request message, the VSGSN (i) selects a given VGGSN within the visited or roaming network 405A for supporting the given multimedia service and loads the selected VGGSN's address from the table, (ii) determines a local APN to be used for supporting the given multimedia service within the visited or roaming network 405A, and then (iii) generates a Create PDP Context Request message that includes the local APN instead of the APN included within the Activate PDP Context Request message and is addressed to the selected VGGSN's address, 620B. Referring to 620B of FIG. 6B, the determination of the local APN can be based upon the VSGSN determining that the visited or roaming network 405A provides special treatment based on APN, such as Expedited Forwarding over backhauls. Accordingly, replacing the initial APN with the local APN within the Create PDP Context Request message can be used to improve performance for the multimedia service when supported locally within the visited or roaming network 405A.

In another example, still referring to 620B of FIG. 6B, as noted above, it is possible that a listed APN from the table could be stored in association with more VGGSN (e.g., if the visited or roaming network 405A supports multiple VGGSNs that can support the given multimedia service). In this case, the VSGSN can use the local APN to determine the IP address of the GGSN to be selected using Domain Name System (DNS) protocols.

After generating the modified Create PDP Context Request message with the local APN, the VSGSN transmits the modified Create PDP Context Request message to the VGGSN, 625B, after which the process advances to 625A of FIG. 6A whereby the PDP context terminates at the VGGSN completes set-up.

While the embodiments above have been described with reference to GPRS architecture in 2G or W-CDMA-based 3G networks, it will be appreciated that other embodiments can be directed to other types of network architectures and/or protocols. For example, the embodiments described above can be carried over to a Long-Term Evolution (LTE) network, whereby a combination of the RNC and the SGSN maps to a Mobility Management Entity (MME) for control plane and Serving Gateway (S-GW) for user plane traffic in LTE, the Activate PDP Context Request message maps to an Activate default Bearer Request or Public Data Network (PDN) Connectivity Request message in LTE, the PDP context maps to an Evolved Packet System (EPS) Bearer in LTE, and the Home Location Register (HLR) settings map to Home Subscriber Service (HSS) settings in LTE, the GGSN maps to the Packet Data Network (PDN) Gateway, and so on. APNs areused both in UMTS/HSPA and LTE networks for identifying packet data networks (PDNs) and the services within the PDNs.

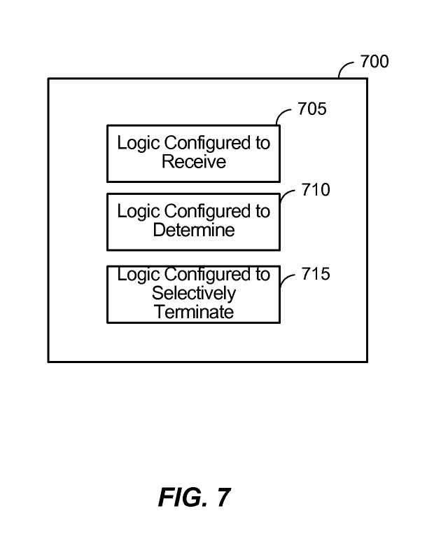

FIG. 7 illustrates an example of logic that can be included in a network end-point (e.g., an SGSN in accordance with GPRS architecture in 2G or W-CDMA-based 3G networks, an MME in accordance with an LTE network, etc.) in accordance with an embodiment of the invention. The network end-point 700 includes at least logic configured to receive 705, logic configured to determine 710 and logic configured to selectively terminate 715. The above-noted logic each includes at least some hardware, such as a processor (e.g., such as an ASIC, etc., described in more detail in paragraphs below), receiver or transmitter. For example, the logic configured to receive 705 can include a given receiver to receive and demodulate a signal, the logic configured to determine 710 can include a given processor configured to evaluate the received signal and make decisions and the logic configured to selectively terminate 715 can include the processor configured to generate a termination signal and a transmitter configured to transmit the termination signal to a target entity. The context of the above-noted logic should be clear from the description of the embodiments above.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating a Serving General Packet Radio Services (GPRS) Support Node (SGSN), comprising:
determining whether a local network is configured to support a given service locally;
receiving, from a user equipment (UE) determined to be roaming within the local network, an Activate Packet Data Protocol (PDP) Context Request message associated with the given service; and
selectively terminating a PDP for the given service within the local network based at least in part upon the determination,
wherein the SGSN is configured to ignore Home Location Register (HLR) settings for PDP termination of the UE.

2. The method of claim 1, wherein the determining step includes:
maintaining a table indicative of services that are supported within the local network locally.

3. The method of claim 2, wherein the table includes a list of Access Point Names (APNs), wherein each listed APN is listed in association with a set of supported services associated and at least one Gateway GPRS Support Node (GGSN).

4. The method of claim 3,
wherein the Activate PDP Context Request message is received in association with a given APN, and
wherein the selectively terminating step includes:
comparing the given APN with the listed APNs to detect a matching APN;
identifying a GGSN associated with the matching APN; and
terminating the PDP for the given service at the identified GGSN.

5. The method of claim 4, wherein the identified GGSN corresponds to a home GGSN.

6. The method of claim 4, wherein the identified GGSN corresponds to a roaming GGSN.

7. The method of claim 6, further comprising:
determining a local APN to be used for supporting the given service within the local network;
generating a Create PDP Context Request message with the local APN instead of the given APN that was received in association with the Activate Packet Data Protocol (PDP) Context Request message.

8. The method of claim 1, wherein the local network is determined to be configured to support the given service locally based on whether the local network satisfies a set of performance requirements specified by the given service.

9. The method of claim 8, wherein the set of performance requirements include support for a threshold level of Quality of Service (QoS).

10. The method of claim 1, wherein the selectively terminating step includes:
terminating the PDP within a home network of the UE if the local network is determined not to be configured to support the given service locally such that the given service is supported via roaming protocols, and
terminating the PDP within the local network if the local network is determined to be configured to support the given service locally.

11. The method of claim 1, wherein the selectively terminating step terminates the PDP for the given service within the local network.

12. The method of claim 1, wherein the selectively terminating step does not terminate the PDP for the given service within the local network.

13. The method of claim 12, wherein the selectively terminating step terminates the PDP for the given service within a home network of the UE.

14. A method of operating a Mobility Management Entity (MME), comprising:
determining whether a local network is configured to support a given service locally;
receiving, from a user equipment (UE) determined to be roaming within the local network, a Public Data Network (PDN) Connectivity Request message associated with the given service; and
selectively terminating an Evolved Packet System (EPS) Bearer for the given service within the local network based at least in part upon the determination,
wherein the MME is configured to ignore Home Subscriber Service (HSS) settings for EPS bearer termination of the UE for the given service.

15. The method of claim 14, wherein the determining step includes:
maintaining a table indicative of services that are supported within the local network locally.

16. The method of claim 15, wherein the table includes a list of Access Point Names (APNs), wherein each listed APN is listed in association with a set of supported services associated and at least one Packet Data Network (PDN).

17. The method of claim 16,
wherein the PDN Connectivity Request message is received in association with a given APN, and
wherein the selectively terminating step includes:
comparing the given APN with the listed APNs to detect a matching APN;
identifying a PDN associated with the matching APN; and
terminating the EPS Bearer for the given service at the identified PDN.

18. The method of claim 17, wherein the identified PDN corresponds to a home PDN.

19. The method of claim 17, wherein the identified PDN corresponds to a roaming PDN.

20. The method of claim 14, wherein the local network is determined to be configured to support the given service locally based on whether the local network satisfies a set of performance requirements specified by the given service.

21. The method of claim 20, wherein the set of performance requirements include support for a threshold level of Quality of Service (QoS).

22. The method of claim 14, wherein the selectively terminating step includes:
terminating the EPS bearer within a home network of the UE if the local network is determined not to be configured to support the given service locally such that the given service is supported via roaming protocols, and
terminating the EPS bearer within the local network if the local network is determined to be configured to support the given service locally.

23. The method of claim 14, wherein the selectively terminating step terminates the EPS bearer for the given service within the local network.

24. The method of claim 14, wherein the selectively terminating step does not terminate the EPS bearer for the given service within the local network.

25. The method of claim 24, wherein the selectively terminating step terminates the EPS bearer for the given service within a home network of the UE.

26. A Serving General Packet Radio Services (GPRS) Support Node (SGSN), comprising:
means for determining whether a local network is configured to support a given service locally;
means for receiving, from a user equipment (UE) determined to be roaming within the local network, an Activate Packet Data Protocol (PDP) Context Request message associated with the given service; and
means for selectively terminating a PDP for the given service within the local network based at least in part upon the determination,
wherein the SGSN is configured to ignore Home Location Register (HLR) settings for PDP termination of the UE.

27. A Mobility Management Entity (MME), comprising:
means for determining whether a local network is configured to support a given service locally;
means for receiving, from a user equipment (UE) determined to be roaming within the local network, a Public Data Network (PDN) Connectivity Request message associated with the given service; and
means for selectively terminating an Evolved Packet System (EPS) Bearer for the given service within the local network based at least in part upon the determination,
wherein the MME is configured to ignore Home Subscriber Service (HSS) settings for EPS bearer termination of the UE for the given service.

28. A Serving General Packet Radio Services (GPRS) Support Node (SGSN), comprising:
logic configured to determine whether a local network is configured to support a given service locally;
logic configured to receive, from a user equipment (UE) determined to be roaming within the local network, an Activate Packet Data Protocol (PDP) Context Request message associated with the given service; and
logic configured to selectively terminate a PDP for the given service within the local network based at least in part upon the determination,
wherein the SGSN is configured to ignore Home Location Register (HLR) settings for PDP termination of the UE.

29. A Mobility Management Entity (MME), comprising:
logic configured to determine whether a local network is configured to support a given service locally;
logic configured to receive, from a user equipment (UE) determined to be roaming within the local network, a Public Data Network (PDN) Connectivity Request message associated with the given service; and
logic configured to selectively terminate an Evolved Packet System (EPS) Bearer for the given service within the local network based at least in part upon the determination,
wherein the MME is configured to ignore Home Subscriber Service (HSS) settings for EPS bearer termination of the UE for the given service.

30. A non-transitory computer-readable storage medium containing instructions stored thereon, which, when executed by a Serving General Packet Radio Services (GPRS) Support Node (SGSN), cause the SGSN to perform operations, the instructions comprising:
program code to determine whether a local network is configured to support a given service locally;
program code to receive, from a user equipment (UE) determined to be roaming within the local network, an Activate Packet Data Protocol (PDP) Context Request message associated with the given service; and
program code to selectively terminate a PDP for the given service within the local network based at least in part upon the determination,
wherein the SGSN is configured to ignore Home Location Register (HLR) settings for PDP termination of the UE.

31. A non-transitory computer-readable storage medium containing instructions stored thereon, which, when executed by a Mobility Management Entity (MME), cause the MME to perform operations, the instructions comprising:
program code to determine whether a local network is configured to support a given service locally;
program code to receive, from a user equipment (UE) determined to be roaming within the local network, a Public Data Network (PDN) Connectivity Request message associated with the given service; and
program code to selectively terminate an Evolved Packet System (EPS) Bearer for the given service within the local network based at least in part upon the determination,
wherein the MME is configured to ignore Home Subscriber Service (HSS) settings for EPS bearer termination of the UE for the given service.
